(19) United States
(12) Patent Application Publication
(10) Pub. No.: US 2025/0332901 A1
(43) Pub. Date: Oct. 30, 2025

(54) BATTERY UNIT

(71) Applicant: MAZDA MOTOR CORPORATION, Hiroshima (JP)

(72) Inventors: Ayaka FUKUDA, Hiroshima (JP); Kota KYOMURE, Hiroshima (JP); Daisuke KANAMARU, Hiroshima (JP); Yui KUROKI, Hiroshima (JP)

(73) Assignee: MAZDA MOTOR CORPORATION, Hiroshima (JP)

(21) Appl. No.: 19/056,946

(22) Filed: Feb. 19, 2025

(30) Foreign Application Priority Data
Apr. 26, 2024 (JP) 2024-072844

(51) Int. Cl. B60K 1/04; B60L 50/60; B60L 50/64; B62D 25/02; B62D 25/20; H01M 50/209; H01M 50/242; H01M 50/249

(52) U.S. Cl. CPC B60K 1/04; B60L 50/64; B60L 50/66; B62D 25/025; B62D 25/2009; H01M 50/209; H01M 50/242; H01M 50/249; B60K 2001/0438; H01M 2220/20

(57) ABSTRACT

A battery case has a pair of first frames extending in a first direction, one of longitudinal-and-lateral directions, and a pair of second frames extending in a second direction, the other of the longitudinal-and-lateral directions, and is configured in a square frame shape such that the first and second frames enclose battery cells. The first frame includes a first contact face arranged to face the second frame and a first connection portion to connect to the second frame. The second frame includes a second contact face arranged to face the first frame and a second connection portion to connect to the first frame. The first frame has a step-shaped first step portion which forms a first space where at least part of the second connection portion of the second frame is stored in least part of the first contact face is provided at the first step portion.

### BACKGROUND OF THE INVENTION

The present invention relates to a battery unit provided below a floor panel of a vehicle, which comprises a battery case and battery cells stored in the battery case.

This kind of battery units is disclosed in Japanese Patent Laid-Open Publication No. 2016-97851, for example. This battery unit comprises a pair of first-and-second longitudinal frames which respectively have a hollow cross section and a pair of first-and-second lateral frames which respectively have another hollow cross section and connect to respective both-end portions of the first-and-second longitudinal frames via respective corner brackets. The corner bracket includes insertion holes to be inserted into respective hollow portions of the longitudinal frames and the lateral frames and an attachment portion to be attached to a vehicle body.

According to the battery unit disclosed in the above-described patent document, the impact resistance against any collision load applied from any direction in a vehicle collision can be properly dispersed to a whole part of the frames by the corner brackets disposed between end portions of the longitudinal frames and end portions of the lateral frames.

The battery unit of the above-described patent document has a structure in which the end portion of the longitudinal frame and the end portion of the lateral frame merely abut each other even if the corner backet is interposed therebetween.

Therefore, when the vehicle has a frontal collision, the collision load cannot be sufficiently transmitted from the lateral frames (extending in the lateral direction) to the longitudinal frames (extending in the longitudinal direction). Meanwhile, in a case where the vehicle has a side collision, the collision load cannot be transmitted to the lateral frames from the longitudinal frames properly.

Thus, there is a concern that the battery cells stored in the battery case may not be protected appropriately against the vehicle frontal or side collisions according to the battery unit of the above-described patent document.

### SUMMARY OF THE INVENTION

An object of the present invention is to provide a battery unit provided below the floor panel of the vehicle which can properly protect the battery cells stored in the battery case against both the vehicle frontal collision and the vehicle side collision.

The present invention is a battery unit which is provided below a floor panel of a vehicle, comprising a battery case provided with a pair of first frames extending in a first direction which is one of a longitudinal direction and a lateral direction and a pair of second frames extending in a second direction which is the other of the longitudinal direction and the lateral direction, and battery cells stored in the battery case, wherein the battery case is configured in a square frame shape such that the first frames and the second frames enclose the battery cells, the first frame includes a first contact face which is arranged to face the second frame and a first connection portion to connect to the second frame and the second frame includes a second contact face which is arranged to face the first frame and a second connection portion to connect to the first frame, the first frame has a step-shaped first step portion which forms a first space where at least part of the second connection portion of the second frame is stored, and at least part of the first contact face of the first frame is provided at the first step portion of the first frame.

Herein, it is assumed, for example, that the first direction is (corresponds to) the lateral direction of the vehicle, whereas the second direction is (corresponds to) the longitudinal direction of the vehicle. When the vehicle frontal collision happens, its collision load is applied to the first frame first, then transmitted to the second frame by way of the first contact face of the first frame. Meanwhile, when the vehicle side collision occurs, its collision load is applied to the second frame first, then transmitted to the first frame by way of the second contact face of the second frame.

To the contrary, in a case where it is assumed that the first direction is the longitudinal direction and the second direction is the lateral direction, the first frame (the first contact face) and the second frame (the second contact face) perform inversely, respectively, and the similar results may be obtained.

Thus, even when the vehicle has both the frontal collision and the side collision, both the collision loads can be supported at the first and second frames properly.

Particularly, the first connection portion of the first frame is provided with the step-shaped first step portion to form the first space. The first space of the first frame stores at least part of the second connection portion of the second frame. At least part of the first contact face is provided at the first step portion of the first frame.

Thereby, the first contact face of the first frame is configured to easily face the second frame. The collision load applied to the first frame can be easily transmitted to the second frame by way of the first contract face.

As described above, in the battery unit provided below the floor panel of the vehicle, the battery cells stored in the battery case can be properly protected against both the vehicle frontal collision and the vehicle side collision.

In an embodiment, the above-described second connection portion frame has a step-shaped second step portion which forms a second space where at least part of the first connection portion is stored, at least part of the above-described contact face is provided at the second step portion, and the first step portion and the second step portion are provided to engage with each other.

The second contact face of the second frame is configured to easily face the first frame. The collision load applied to the second frame can be easily transmitted to the first frame by way of the second contract face. Further, the first step portion of the first frame and the second step portion of the second frame is made to engage with each other, so that the first frame and the second frame can be assembled easily.

In another embodiment, the above-described first step portion of the first frame is configured to be formed in a step shape when viewed in a vertical direction.

In another embodiment, the first step portion of the first frame is configured to be formed in the step shape when viewed in the above-described second direction.

In another embodiment, the above-described second step portion of the second frame is configured to be formed in the step shape when viewed in the vertical direction.

In another embodiment, the above-described second step portion of the second frame is configured to be formed in the step shape when viewed in the above-described first direction.

In another embodiment, the above-described battery case is provided with a pair of lateral frames which are either one of the first frames and the second frames and extend in the lateral direction and a pair of longitudinal frames which are the other of the first frames and the second frames and extend in the longitudinal direction, the lateral frame includes a lateral-frame-side contact face which is either one of the first contact face and the second contact face, the vehicle comprises a pair of front side frames which extend forward from a forward side of the floor panel with a specified gap (distance) formed, in the lateral direction, therebetween and form a vehicle body together with the floor panel, and the lateral-frame-side contact face of the lateral frame positioned on the forward side is provided to face the longitudinal frame and located at a specified position so as to overlap with a rear end portion of the front side frame in a vertical direction.

When the vehicle frontal collision happens, its collision load is applied to the front side frame first, then transmitted to the front-side lateral frame from the rear end portion of the front side frame, and finally transmitted to the longitudinal frame by way of the lateral-frame-side contact face of the front-side lateral frame. The lateral-frame-side contact face of the front-side lateral frame is located at the specified position so as to overlap with the rear end portion of the front side frame in the vertical direction. Thus, the collision load of the vehicle frontal collision can be smoothly transmitted to the front side frame, the front-side lateral frame, and the longitudinal frame in order.

In another embodiment, the battery case is provided with a pair of longitudinal frames which are either one of the first frames and the second frames and extend in the longitudinal direction and a pair of lateral frames which are the other of the first frames and the second frames and extend in the lateral direction, the longitudinal frame includes a longitudinal-frame-side contact face which is either one of the first contact face and the second contact face, the vehicle comprises a pair of side sills which extend in the longitudinal direction along both-side edge portions, in the lateral direction, of the floor panel and form a vehicle body together with the floor panel, the longitudinal frame is fixed to the side sill with a fixation member, and the longitudinal-frame-side contact face of the longitudinal frame is provided to face the lateral frame and located at a specified position so as to overlap with the fixation member in the vertical direction.

When the vehicle side collision happens, its collision load is applied to the side sill first, then transmitted to the longitudinal frame by way of the fixation member (to fix the longitudinal frame to the side sill), and finally transmitted to the lateral frame by way of the longitudinal-frame-side contact face of the longitudinal frame. The longitudinal-frame-side contact face of the longitudinal frame is located at the specified position so as to overlap with the fixation member in the vertical direction. Thus, the collision load of the vehicle side collision can be smoothly transmitted to the side sill, the fixation member, the longitudinal frame, and the lateral frame in order.

According to the present invention, the battery cells stored in the battery case can be properly protected against both the vehicle frontal collision and the vehicle side collision in the battery unit provided below the floor panel of the vehicle.

The present invention will become apparent from the following description which refers to the accompanying drawings.

### BRIEF DESCRIPTION OF THE DRAWINGS

FIG. 1 is an upper view of a vehicle-body structure of a vehicle according to a first embodiment, when viewed from an upper side.

FIG. 2 is a perspective view of the vehicle-body structure of the vehicle according to the first embodiment.

FIG. 3 is a view of a battery unit according to the first embodiment.

FIG. 4 is an upper view of details of a connection point of a longitudinal frame and a lateral frame according to the first embodiment, when viewed from the upper side.

FIG. 5 is a view showing a positional relationship between the lateral frame and a front side frame according to the first embodiment.

FIG. 6 is a view showing a positional relationship between the longitudinal frame and a side sill according to the first embodiment.

FIG. 7 is an upper view of details of a connection point of the longitudinal frame and the lateral frame according to a second embodiment, when viewed from the upper side.

FIG. 8 is a perspective view of details of a connection point of the longitudinal frame and the lateral frame according to a third embodiment.

### DETAILED DESCRIPTION OF THE INVENTION

Hereafter, embodiments of the present invention will be specifically described referring to the accompanying drawings. The following description of the embodiments relate to exemplifications of the present invention, and therefore the present invention is not be limited in its applications or uses by that.

### Embodiment 1

A battery unit 30 of a vehicle A according to a first embodiment will be described. In the following description, a longitudinal direction, a lateral direction, and a vertical direction are respectively defined based on a relative position to the vehicle A. In the figures, these directions are shown by respective arrows. The longitudinal direction is an advancing direction of the vehicle A. The longitudinal direction is an example of the second direction according to the present invention, which is shown by an arrow X. The lateral direction matches a vehicle width direction of the vehicle A. The lateral direction is an example of the first direction of the present invention, which is shown by an arrow Y. The vertical direction corresponds to a height direction of the vehicle A, which is shown by an arrow Z.

### (Vehicle-Body Structure)

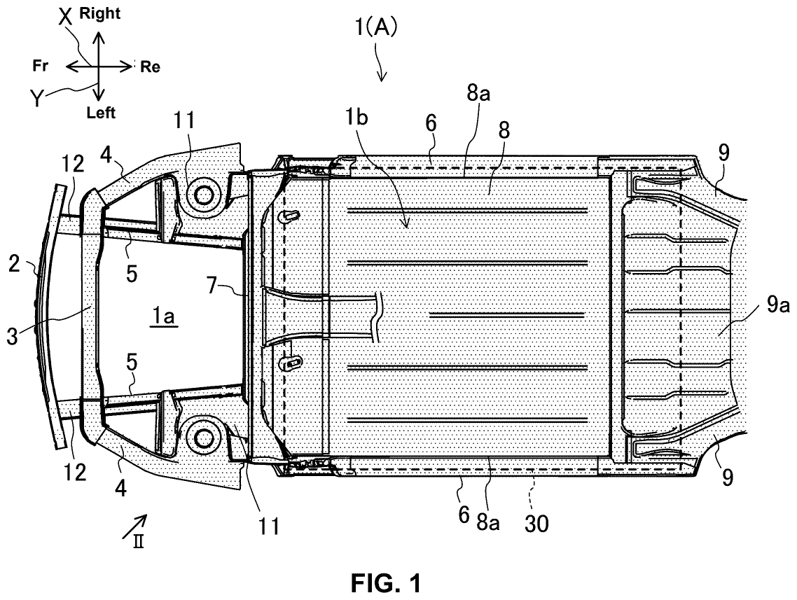

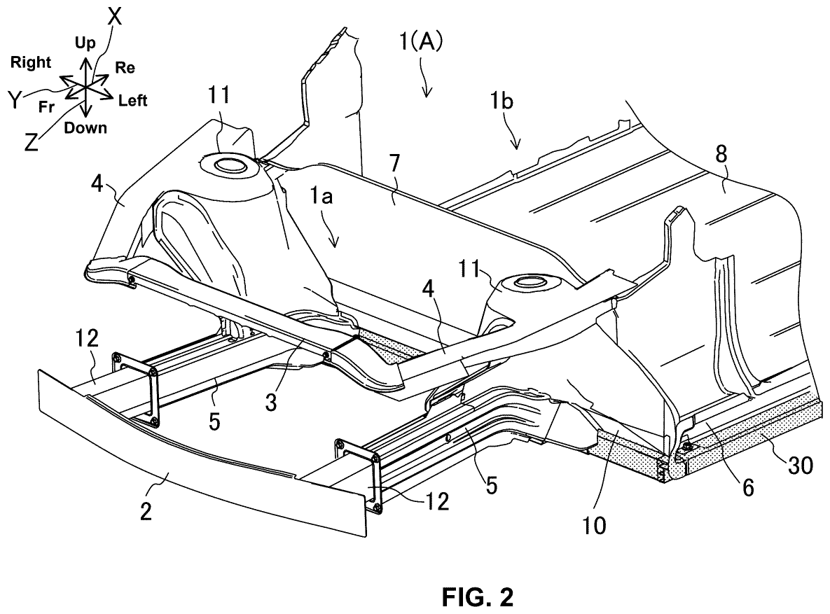

FIG. 1 is an upper view of a structure of a vehicle body 1 of the vehicle A, when viewed from an upper side. FIG. 2 is a perspective view of the structure of the vehicle body 1 of the vehicle A, when viewed from a direction of an arrow II in FIG. 1. As shown in FIG. 1, the vehicle A comprises a bumper beam 2, a shroud upper member 3, a pair of apron members 4, a pair of front side frames 5, a pair of side sills 6, a dash panel 7, a floor panel 8, and a pair of rear side frames 9. The vehicle A further comprises a pair of torque boxes 10, a pair of suspension housing 11, and a pair of crash cans 12. The vehicle A has a battery unit 30.

The vehicle A is an electric automobile driven by an electric motor. This motor (not illustrated) is installed in a front-side space la provided at a front part of the vehicle body 1. A cabin 1b is formed at a middle part of the vehicle body 1. A floor panel 8 is provided at the middle part of the vehicle body 1 as well. The floor panel 8 extends in the longitudinal direction and in the lateral direction, which is of a roughly rectangular shape when viewed in the vertical direction. The floor panel 8 forms a floor face of the cabin 1b.

A battery unit 30 is installed at the vehicle A. The battery unit 30 is an electric source to drive the motor for traveling of the vehicle A. As shown by a broken line in FIG. 1, the battery unit 30 is provided below the floor panel 8 of the vehicle A such that it extends along the floor panel 8.

The battery unit 30 has a rectangular exterior view in a plan view which substantially matches the floor panel 8. The battery unit 30 will be described later.

As shown in FIG. 2, the dash panel 7 partitions the front-side space 1a from the cabin 1b. This dash panel 7 extends in the vertical direction and in the lateral direction.

A pair of side sills 6 are provided at right-and-left both sides of the middle part of the vehicle body 1. The side sill 6 is made of a pole-shaped member and superior in strength and rigidity. The side sills 6 extend in the longitudinal direction in parallel along both-side edge portions 8a, in the lateral direction, of the floor panel 8. The side sills 6 form the vehicle body 1 together with the floor panel 8.

A pair of rear side frames 9 are connected to respective rear ends of the pair of side sills 6. The rear side frames 9 extend rearward. A rear floor panel 9a is provided between the rear side frames 9 such that it is continuous from the floor panel 8.

As shown in FIGS. 1 and 2, a pair of front side frame 5 extend forward from a front side of the floor panel 8 such that they are separated from each other in the lateral direction. The front side frames 5 form the vehicle body 1 together with the floor panel 8. The front side frames 5 extend slightly obliquely forward-and-outward, in the lateral direction, of the vehicle body 1 when viewed in the vertical direction. Each of the front side frame frames 5 is made of a pole-shaped member which has a rectangular cross section.

The front side frame 5 is joined to a front end portion of the floor panel 8 and the torque box 10.

The suspension housing 11 is provided at a frond side of each of both-end portions, in the lateral direction, of the dash panel 7. A lower end of the suspension housing 11 is connected to the front side frame 5. An apron member 4 is connected to an upper end portion of the suspension housing 11.

The apron member 4 extends forward from an outward side of the suspension housing 11. The apron member 4 is curved inward toward a vehicle forward side. Respective front ends of the booth apron members 4 are interconnected by the shroud upper member 3 extending in the lateral direction.

The bumper beam 2 extending in the lateral direction is arranged below and in front of the shroud upper member 3. Respective front ends of the front side frame 5 are connected to both-side end portions, in the lateral direction, of the bumper beam 2 via respective crash cans 12.

### (Battery Unit)

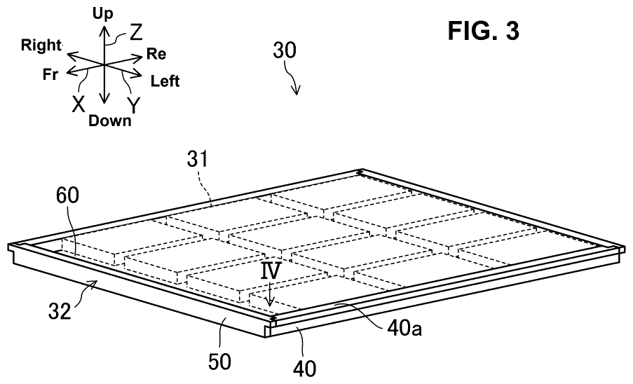

FIG. 3 shows the battery unit 30 of the first embodiment. The battery unit 30 comprises plural battery cells 31 and the battery case 32. The plural battery cells 31 are stored at the battery case 32. The battery unit 32 is arranged below the floor panel 8 of the vehicle A in a state where the battery cells 31 are stored at the battery case 32.

The battery cell 31 is made from lithium-ion battery or the like. The plural battery cells 31 are all connected electrically and able to produce a specified high-voltage output. Each batter cell 31 is formed in a rectangular-block shape (rectangular parallelepiped), considering its efficient installment. In the present embodiment, the twelve battery cells 31 are arranged closely to each other inside the battery case 32 such that four of them are aligned in the lateral direction and three of them are aligned in the longitudinal direction.

The battery case 32 comprises a pair of longitudinal frames 40, a pair of lateral frames 50, and a bottom member 60. The longitudinal direction 40 is an example of the second frame of the present invention. The lateral frame 50 is an example of the first frame of the present invention.

The longitudinal frames 40 extend in the longitudinal direction in parallel such that they are separated from each other in the lateral direction. Meanwhile, the lateral frames 50 extend in the lateral direction in parallel such that they are separated from each other in the longitudinal direction. The battery case 32 is configured such that the lateral frames 50 and the longitudinal frames 40 are combined in a square-frame shape in the plane view, enclosing the battery cells 31. In details, the battery case 32 is formed in a rectangular shape with its long side extending in the longitudinal direction and its short side extending in the lateral direction.

Hereinafter, there is a case where the direction toward an inside of the battery case 32 in the longitudinal direction (the lateral direction) (i.e., the side where the battery cells 31 are arranged) is called an inward side of the longitudinal direction (the lateral direction) and the direction toward an outside of the battery case 32 in the longitudinal direction (the lateral direction) (i.e., the side where the battery cells 31 are not arranged) is called an outward side of the longitudinal direction (the lateral direction).

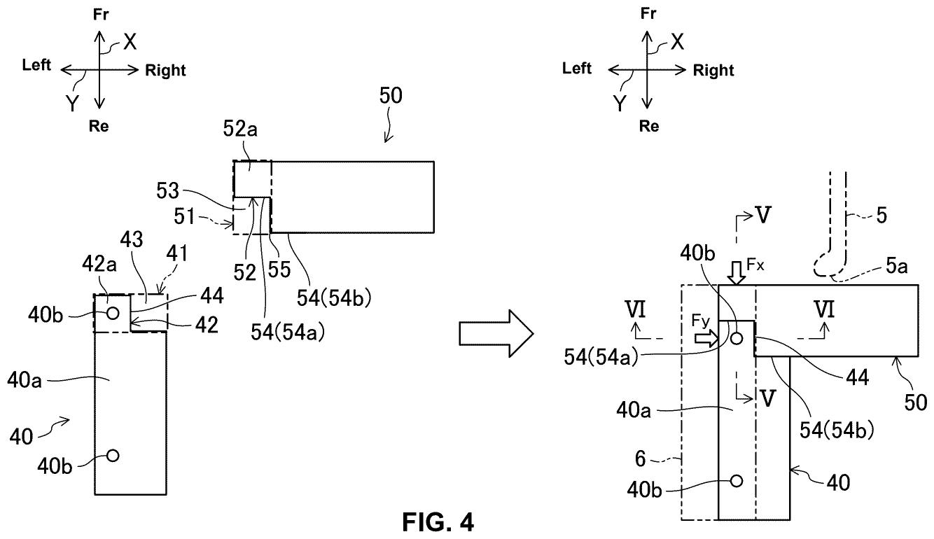

The longitudinal frame 40 is made of a square pipe. The longitudinal frame 40 has an inverse-L shaped cross section. A flange portion 40a protruding outward in the lateral direction is formed integrally at an upper portion of the longitudinal frame 40. Fixation holes 40b are formed at plural points of the flange portion 40a of the longitudinal frame 40 (see FIG. 4). These plural points are separated from each other in the longitudinal direction of the flange portion 40a. The fixation hole 40b is provided to penetrate the flange portion 40a in the vertical direction. A fixation member 70 for fixing the longitudinal frame 40 to the side sill 6 is inserted into the fixation hole 40b, which is not described specifically.

The lateral fame 50 is made of another square pipe. The lateral frame 50 has a square-shaped cross section. Each of the longitudinal frame 40 and the lateral frame 50 is an extruded aluminum frame, for example.

The bottom member 60 is a plate member to form a bottom face of the battery case 32. The bottom member 60 covers a lower portion of the longitudinal frame 40, a lower portion of the lateral frame 50, and a space enclosed by the longitudinal frame 40 and the lateral frame 50 from below. A lid member to cover over the battery case 32 may be provided, which is not illustrated here.

(Connection Point between Longitudinal Frame and Lateral Frame)

FIG. 4 is an upper view of details of a connection point of the longitudinal frame 40 and the lateral frame 50, when viewed from the upper side. FIG. 4 shows an area of IV shown in FIG. 3.

A step-shaped longitudinal-frame-side step portion 42 is provided at a longitudinal-frame-side connection portion 41 of the longitudinal frame 40 to the lateral frame 50. The longitudinal-frame-side connection portion 41 is an example of the second connection portion of the present invention. The longitudinal-frame-side connection portion 41 is a connection point of the longitudinal frame 40 to the lateral frame 50 (see a two-dotted line in FIG. 4). The longitudinal-frame-side step portion 42 is an example of the second step of the present invention. The longitudinal-frame-side step portion 42 is formed in a step shape when viewed in the vertical direction.

Specifically, the longitudinal-frame-side step portion 42 includes a longitudinal projection portion 42a. The longitudinal projection portion 42a extends toward the outside of the longitudinal direction and in the vertical direction at a point located at an outside end portion, in the longitudinal direction, and an outside portion, in the lateral direction, of the longitudinal frame 40. A longitudinal-frame-side space 43 is formed at a point located at the outside end portion, in the longitudinal direction, and an inside portion, in the lateral direction, of the longitudinal frame 40. The longitudinal-frame-side space 43 is an example of the second space of the present invention. The longitudinal-frame-side step portion 42 forms a longitudinal-frame-side space 43.

The longitudinal frame 40 includes a longitudinal-frame-side contact face 44. The longitudinal-frame-side contact face 44 is an example of the second contract face of the present invention. The longitudinal-frame-side contact face 44 is provided to face the inward side in the lateral direction so as to face the lateral frame 50. At least part of the longitudinal-frame-side contact face 44 is provided at the longitudinal-frame-side step portion 42. Specifically, the longitudinal-frame-side contact face 44 is provided at a face which faces the inward side, in the lateral direction, of the longitudinal projection portion 42a of the longitudinal-frame-side step portion 42. In this example, a whole part of the longitudinal-frame-side contact face 44 is provided at the longitudinal-frame-side step portion 42.

A step-shaped lateral-frame-side step portion 52 is provided at the lateral-frame-side connection portion 51 of the lateral frame 50 to the longitudinal frame 40. The lateral-frame-side connection portion 51 is an example of the first connection portion of the present invention. The lateral-frame-side connection portion 51 is a connection point of the lateral frame 50 to the longitudinal frame 40 (see the two-dotted line in FIG. 4). The lateral-frame-side step portion 52 is an example of the first step portion of the present invention. The lateral-frame-side step portion 52 is formed in the step shape when viewed in the vertical direction.

Specifically, the lateral-frame-side step portion 52 includes a lateral projection portion 52a. The lateral projection portion 52a extends in the lateral direction and in the vertical direction at a point located at an outside end portion, in the lateral direction, of the lateral frame 50 and an outside portion, in the longitudinal direction, of the lateral frame 50. A lateral-frame-side space 53 where the lateral projection 52a does not exist is formed at a point located at the outside end portion, in the lateral direction, of the lateral frame 50 and an inside portion, in the longitudinal direction, of the lateral frame 50. The lateral-frame-side space 53 is an example of the first space of the present invention. The lateral-frame-side step portion 52 forms the lateral-frame-side space 53.

The longitudinal-frame-side step portion 42 of the longitudinal frame 40 and the lateral-frame-side step portion 52 of the lateral frame 50 engage with each other.

The lateral frame 50 includes a lateral-frame-side contact face 54. The lateral-frame-side contact face 54 is an example of the first contact face of the present invention. The lateral-frame-side contact face 54 is provided to face the longitudinal frame 40. At least part of the lateral-frame-side contact face 54 is provided at the lateral-frame-side step portion 52. Specifically, a portion 54a of the lateral-frame-side contact face 54 is provided at a face portion of the lateral projection portion 52a of the lateral-frame-side step portion 52 which faces the inward side in the longitudinal direction. Another portion 54b of the lateral-frame-side contact face 54 is provided at a face of a corner portion 55 of the lateral-frame-side connection portion 51 which is positioned slightly on the inward side, in the lateral direction, of the lateral-frame-side step portion 52.

The longitudinal-frame-side space 43 of the longitudinal frame 40 stores at least part of the lateral-frame-side connection portion 51 of the lateral frame 50. Specifically, the longitudinal-frame-side space 43 of the longitudinal frame 40 stores the corner portion 55 of the lateral-frame-side connection portion 51 of the lateral frame 50.

The lateral-frame-side space 53 of the lateral frame 50 stores at least part of the longitudinal-frame-side connection portion 41 of the longitudinal frame 40. Specifically, the lateral-frame-side space 53 of the lateral frame 50 stores the longitudinal projection portion 42a of the longitudinal-frame-side step portion 42 at the longitudinal-frame-side connection portion 41 of the longitudinal frame 40.

(Positional Relationship between Lateral Frame and Front Side Frame)

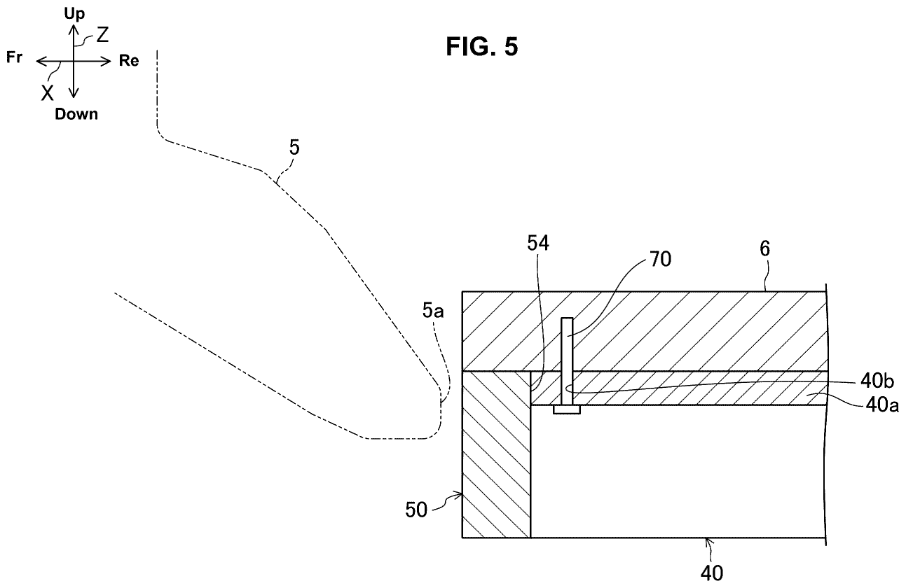

FIG. 5 is a sectional view showing a positional relationship between the lateral frame 50 and the front side frame 5, when viewed from a direction of an arrow V in FIG. 4. The lateral-frame-side contact face 54 of the front-side lateral frame 50 faces the longitudinal frame 40. The lateral-frame-side contact face 54 of the front-side lateral frame 50 is located at a specified position so as to overlap with a rear end portion 5a of the front side frame 5 in the vertical direction.

(Positional Relationship between Longitudinal Frame and Side Sill)

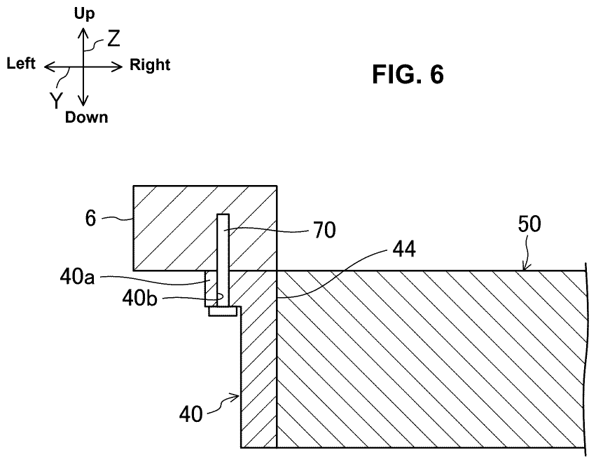

FIG. 6 is a sectional view showing a positional relationship between the longitudinal frame 40 and the side sill 6, when viewed from a direction of an arrow VI in FIG. 4.

A flange portion 40a which protrudes outward is formed integrally with an upper portion of the longitudinal frame 40. The side sill 6 is arranged above the flange portion 40a of the longitudinal frame 40. The flange portion 40a of the longitudinal frame 40 is fixed to the side sill 6. Specifically, the flange portion 40a of the longitudinal frame 40 is fixed to the side sill 6 by a fixation member 70. The fixation member 70 is inserted into a fixation hole 40b which is provided at the flange portion 40a. The fixation member 70 is a bolt, for example.

The longitudinal-frame-side contact face 44 of the longitudinal frame 40 faces the lateral frame 50. This longitudinal-frame-side contact face 44 is located at a specified position so as to overlap with the fixation member 70 in the vertical direction.

### (Effects)

When the vehicle A has a frontal collision, a collision load of the vehicle frontal collision (hereafter, referred to as a “frontal-collision load Fx”) is applied to the lateral frame 50 first, and then transmitted to the longitudinal frame 40 by way of the lateral-frame-side contact face 54 of the lateral frame 50. Meanwhile, when the vehicle A has a side collision, a collision load of the vehicle side collision (hereafter, referred to as a “side-collision load Fy”) is applied to the longitudinal frame 40 first, and then transmitted to the lateral frame 50 by way of the longitudinal-frame-side contact face 44 of the lateral frame 40.

Thus, even when the vehicle A has the frontal collision or the side collision, the collision load can be supported by the lateral frame 50 or the longitudinal frame 40.

The step-shaped lateral-frame-side step portion 52 to form the lateral-frame-side space 53 is provided at the lateral-frame-side connection portion 51 of the lateral frame 50. The lateral-frame-side space 53 of the lateral frame 50 stores at least part of the longitudinal-frame-side connection portion 41 of the longitudinal frame 40. At least part of the lateral-frame-side contact face 54 of the lateral frame 50 is provided at the lateral-frame-side step portion 52.

Thus, the lateral-frame-side contact face 54 of the lateral frame 50 faces the longitudinal frame 40. Thereby, the frontal-collision load Fx applied to the lateral frame 50 is transmitted to the longitudinal frame 40 by way of the lateral-frame-side contact face 54.

Likewise, the step-shaped longitudinal-frame-side step portion 42 to form the longitudinal-frame-side space 43 is provided at the longitudinal-frame-side connection portion 41 of the longitudinal frame 40. The longitudinal-frame-side space 43 of the longitudinal frame 40 stores at least part of the lateral-frame-side connection portion 51 of the lateral frame 50. At least part of the longitudinal-frame-side contact face 44 of the longitudinal frame 40 is provided at the longitudinal-frame-side step portion 42.

Thus, the longitudinal-frame-side contact face 44 of the longitudinal frame 40 faces the lateral frame 50. Thereby, the side-collision load Fy applied to the longitudinal frame 40 is transmitted to the lateral frame 50 by way of the longitudinal-frame-side contact face 44.

As described above, in the battery unit 30 provided below the floor panel 8 of the vehicle A, the battery cells 31 stored in the battery case 32 can be properly protected against both the vehicle frontal collision and the vehicle side collision.

Further, the lateral-frame-side step portion 52 of the lateral frame 50 and the longitudinal-frame-side step portion 42 of the longitudinal frame 40 are made to engage with each other, so that the lateral frame 50 and the longitudinal frame 40 can be assembled easily.

When the frontal collision of the vehicle A happens, the frontal-collision load Fx is applied to the front side frame 5 first, then transmitted to the front-side lateral frame 50 from the rear end portion 5a of the front side frame 5, and finally transmitted to the longitudinal frame 40 by way of the lateral-frame-side contact face 54 of the front-side lateral frame 50. The lateral-frame-side contact face 54 of the front-side lateral frame 50 is located at the specified position so as to overlap with the rear end portion 5a of the front side frame 5 in the vertical direction.

Thus, the frontal-collision load Fx can be smoothly transmitted to the front side frame 5, the front-side lateral frame 50, and the longitudinal frame 40 in order.

When the side collision of the vehicle A happens, its collision load is applied to the side sill 6 first, then transmitted to the longitudinal frame 40 by way of the fixation member 70 (to fix the longitudinal frame 40 to the side sill 6), and finally transmitted to the lateral frame 50 by way of the longitudinal-frame-side contact face 44 of the longitudinal frame 40. The longitudinal-frame-side contact face 44 of the longitudinal frame 40 is located at the specified position so as to overlap with the fixation member 70 in the vertical direction.

Thus, the side-collision load Fy can be smoothly transmitted to the side sill 6, the fixation member 70, the longitudinal frame 40, and the lateral frame 50 in order.

### Embodiment 2

A second embodiment will be described. In the following description, the same structures as the above-described embodiment have the same reference characters and their specific descriptions are omitted here.

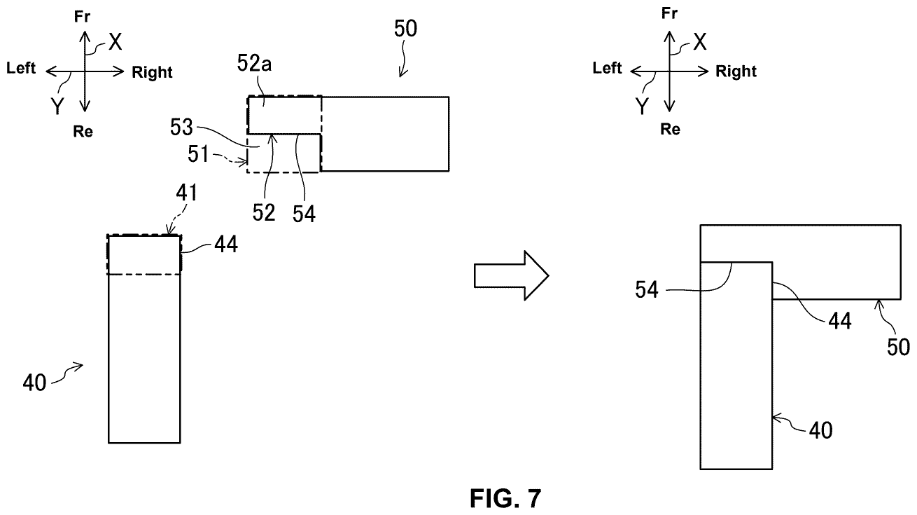

FIG. 7 is an upper view of details of a connection point of the longitudinal frame 40 and the lateral frame 50 according to the second embodiment, when viewed from the upper side.

In the present embodiment, similarly to the first embodiment, the lateral-frame-side connection portion 51 of the lateral frame 50 to the longitudinal frame 40 is provided with the step-side lateral-frame-side step portion 52. However, differently from the first embodiment, the step-shaped longitudinal-frame-side step portion 42 is not provided at the longitudinal-frame-side connection portion 41 of the longitudinal frame 40 to the lateral frame 50 in the present embodiment.

The lateral-frame-side space 53 of the lateral frame 50 stores a whole part of the longitudinal-frame-side connection portion 41 of the longitudinal frame 40.

The other structure is the same as the first embodiment. The present embodiment provides the same effects as the first embodiment.

### EMBODIMENT 3

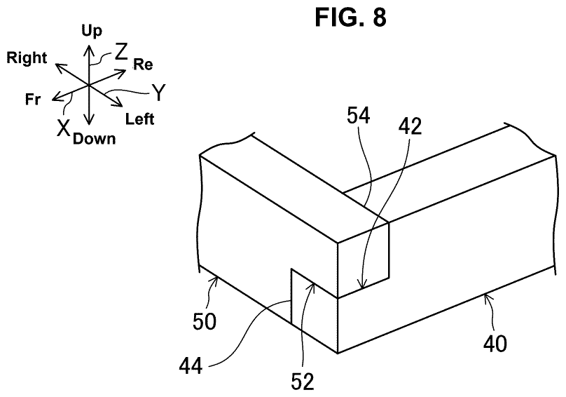

A third embodiment will be described. In the following description, the same structures as the above-described embodiments have the same reference characters and their specific descriptions are omitted here. FIG. 8 is a perspective view of details of a connection point of the longitudinal frame 40 and the lateral frame 50 according to a third embodiment.

In the present embodiment, the longitudinal-frame-side step portion 42 is formed in the step shape when viewed in the lateral direction. The lateral-frame-side step portion 52 is formed in the step shape when viewed in the longitudinal direction.

The other structure is the same as the first embodiment. The present embodiment provides the same effects as the first embodiment.

### Other Embodiments

The present invention is not limited to the above-described embodiments, but any other modifications, replacements, or combinations are applicable.

In the above-described embodiments, the first direction is set at the lateral direction and the second direction is set at the longitudinal direction, but these are not to be limited. That is, the first direction may be the lateral direction and the second direction may be the longitudinal direction. In this case, the same effects can be obtained as well.

The first direction of the present invention is either one of the longitudinal direction and the lateral direction. In this case, the second direction is the other one. The longitudinal frame 40 is either one of the first frame and the second frame of the present invention. Likewise, the lateral-frame-side contact face 54 is either one of the first contact face and the second contact face of the present invention. The longitudinal-frame-side contact face 44 is the other one.

The present invention is applicable to the battery unit, and therefore it is very useful and has the high availability in this industrial field.

What is claimed is:

1. A battery unit which is provided below a floor panel of a vehicle, comprising:
a battery case provided with a pair of first frames extending in a first direction which is one of a longitudinal direction and a lateral direction and a pair of second frames extending in a second direction which is the other of the longitudinal direction and the lateral direction; and
battery cells stored in the battery case,
wherein said battery case is configured in a square frame shape such that said first frames and said second frames enclose said battery cells,
said first frame includes a first contact face which is arranged to face said second frame and a first connection portion to connect to said second frame and said second frame includes a second contact face which is arranged to face said first frame and a second connection portion to connect to said first frame,
said first frame has a step-shaped first step portion which forms a first space where at least part of said second connection portion of the second frame is stored, and
at least part of said first contact face of the first frame is provided at said first step portion of the first frame.

2. The battery unit of claim 1, wherein said second frame has a step-shaped second step portion which forms a second space where at least part of said first connection portion of the first frame is stored, at least part of said second contact face of the second frame is provided at said second step portion of the second frame, and said first step portion and said second step portion are provided to engage with each other.

3. The battery unit of claim 1, wherein said first step portion of the first frame is configured to be formed in a step shape when viewed in a vertical direction.

4. The battery unit of claim 1, wherein said first step portion of the first frame is configured to be formed in a step shape when viewed in said second direction.

5. The battery unit of claim 2, wherein said second step portion of the second frame is configured to be formed in a step shape when viewed in a vertical direction.

6. The battery unit of claim 2, wherein said second step portion of the second frame is configured to be formed in a step shape when viewed in said first direction.

7. The battery unit of claim 1, wherein said battery case is provided with a pair of lateral frames which are either one of said first frames and said second frames and extend in the lateral direction and a pair of longitudinal frames which are the other of said first frames and said second frames and extend in the longitudinal direction, said lateral frame includes a lateral-frame-side contact face which is either one of said first contact face and said second contact face, said vehicle comprises a pair of front side frames which extend forward from a forward side of said floor panel with a specified gap formed, in the lateral direction, therebetween and form a vehicle body together with the floor panel, and said lateral-frame-side contact face of the lateral frame positioned on the forward side is provided to face said longitudinal frame and located at a specified position so as to overlap with a rear end portion of said front side frame in a vertical direction.

8. The battery unit of claim 1, wherein said battery case is provided with a pair of longitudinal frames which are either one of said first frames and said second frames and extend in the longitudinal direction and a pair of lateral frames which are the other of said first frames and said second frames and extend in the lateral direction, said longitudinal frame includes a longitudinal-frame-side contact face which is either one of said first contact face and said second contact face, said vehicle comprises a pair of side sills which extend in the longitudinal direction along both-side edge portions, in the lateral direction, of said floor panel and form a vehicle body together with the floor panel, said longitudinal frame is fixed to said side sill with a fixation member, and said longitudinal-frame-side contact face of the longitudinal frame is provided to face said lateral frame and located at a specified position so as to overlap with said fixation member in a vertical direction.

9. The battery unit of claim 2, wherein said first step portion of the first frame is configured to be formed in a step shape when viewed in a vertical direction.

10. The battery unit of claim 2, wherein said first step portion of the first frame is configured to be formed in a step shape when viewed in said second direction.

11. The battery unit of claim 2, wherein said battery case is provided with a pair of lateral frames which are either one of said first frames and said second frames and extend in the lateral direction and a pair of longitudinal frames which are the other of said first frames and said second frames and extend in the longitudinal direction, said lateral frame includes a lateral-frame-side contact face which is either one of said first contact face and said second contact face, said vehicle comprises a pair of front side frames which extend forward from a forward side of said floor panel with a specified gap formed, in the lateral direction, therebetween and form a vehicle body together with the floor panel, and said lateral-frame-side contact face of the lateral frame positioned on the forward side is provided to face said longitudinal frame and located at a specified position so as to overlap with a rear end portion of said front side frame in a vertical direction.

12. The battery unit of claim 2, wherein said battery case is provided with a pair of longitudinal frames which are either one of said first frames and said second frames and extend in the longitudinal direction and a pair of lateral frames which are the other of said first frames and said second frames and extend in the lateral direction, said longitudinal frame includes a longitudinal-frame-side contact face which is either one of said first contact face and said second contact face, said vehicle comprises a pair of side sills which extend in the longitudinal direction along both-side edge portions, in the lateral direction, of said floor panel and form a vehicle body together with the floor panel, said longitudinal frame is fixed to said side sill with a fixation member, and said longitudinal-frame-side contact face of the longitudinal frame is provided to face said lateral frame and located at a specified position so as to overlap with said fixation member in a vertical direction.
